(19) United States
(12) Patent Application Publication
(10) Pub. No.: US 2021/0331126 A1
(43) Pub. Date: Oct. 28, 2021

(54) Notched Stirring Devices Having Additional Functionalities And Methods For Producing The Same

(71) Applicant: Jaime Fowler, Carson City, NV (US)

(72) Inventor: Jaime Fowler, Carson City, NV (US)

(21) Appl. No.: 17/242,260

(22) Filed: Apr. 27, 2021

Related U.S. Application Data
(60) Provisional application No. 63/015,811, filed on Apr. 27, 2020.

(51) Int. Cl. B01F 13/00; B01F 15/00; A47G 19/22

(52) U.S. Cl. CPC B01F 13/002; B01F 2215/0022; A47G 19/2227; B01F 15/00922

(57) ABSTRACT

A notched stirring device having additional functionalities includes a decorative element forming a grip for a user, a piercing tip for protruding through a garnish, and an elongated body that spans between the decorative element and the piercing tip. The decorative element may be formed in a fanciful shape to facilitate identification. The elongated body forms one or more functional notches and may support (or restrain) one or more items of garnish. The one or more functional notches include a first notch for receiving a first lip of the vessel so that the stirring device may be removably attached to the vessel. In certain embodiments, the stirring device includes a second notch for receiving a second lip of the vessel to secure the stirring device in a horizontal position with the garnish safely above the level of the liquid in the vessel. The notched stirring device may additionally have a vertical hanging notch for positioning the stirring device in a vertical orientation.

### CROSS-REFERENCES TO RELATED APPLICATIONS

This non-provisional utility application takes priority to the previously filed provisional application: Application No. 63/015,811 titled “System and Methods for a Stirring Device Having Additional Functionality” and filed on Apr. 27, 2020 which is hereby incorporated in its entirety by reference.

### SUMMARY OF THE INVENTION

The present invention is generally related to stirring devices for use with beverages and other liquids, and more particularly related to one or more notched stirring devices having a shape that provides one or more additional functionalities which may allow the stirring devices to be used to stir liquids to mix contents, to be used to carry garnishes, and/or to be used to identify or mark a beverage or other liquid so that the beverage or other liquids may be associated with a particular person or user.

The herein disclosed notched stirring device is preferably utilized with a beverage (or in a beverage) and therefore the present invention may be associated with the beverage industry. But the notched stirring devices may be advantageously utilized with other liquids, such as drinks and soups, and may be utilized with a wide variety of liquid-holding vessels such as cups, mugs, bowls, glass vessels, bottles, cans, or other containers. Thus the present invention is not limited to use with beverages or in the beverage industry, but may be utilized with any container for holding any liquid or other viscous material.

The notched stirring device comprises: a decorative element forming a grip for a user, a piercing tip for protruding through a garnish, and an elongated body that spans between the decorative element and the piercing tip. The decorative element may be formed in a fanciful shape to facilitate identification of any of the following: identification of the owner of the drinking vessel (or owner of the contents of the drinking vessel—to identify whose drink it is at a party, for example); identification of the contents of the drinking vessel; identification of the garnish; identification of the origin of the stirring device (to promote a brand, for example). The elongated body forms one or more functional notches and may support (or restrain) one or more items of garnish. The one or more functional notches may include a first notch for receiving a first lip of the vessel.

In a preferred embodiment, the one or more functional notches includes a first notch for receiving a first lip of the vessel and a second notch for receiving a second lip of the vessel. The second lip refers to the lip that is opposite from the first lip, whether the vessel is round or otherwise. The purpose of the preferred embodiment is to provide a relatively secure (but still removable) connection between the stirring device and the lip of the vessel so that the notched stirring device may be suspended across the drinking vessel and may support one or more items of garnish in a desired position in the drinking vessel. In the preferred embodiment, the first notch and the second notch are oriented so that when they are both engaged with their respective vessel lips, the stirring device lies approximately horizontally across the vessel. In other words, in a preferred embodiment the stirring device lies flat across the vessel and is removably secured via the first notch and the second notch.

In an alternative preferred embodiment, the notched stirring device may additionally (or may instead) include a vertical hanging notch for positioning the stirring device in a vertical orientation so that the decorative element is positioned at a high point and the piercing tip is positioned at a lower point. The vertical hanging notch is preferably formed at an angle to allow the notched stirring device to balance appropriately in the vertical orientation. In this vertical orientation, any garnish that is being held by the notched stirring device essentially hangs from the rim or lip of the drinking vessel via the stirring device.

### BACKGROUND OF THE INVENTION

Drink stirrers have been used in various alcoholic and non-alcoholic drinks for many years. They are used to hold and deliver garnishes or other items, such as fruit, vegetables, herbs or other garnishes or other items for eventual inclusion in the user's drink, for separate consumption by the user or for simple aesthetic enhancement of the look of the drink. For this usage, the one or more garnishes, or other items, are attached to the drink stirrer, the stirrer piercing the garnish and protruding from the other side of the garnish, and held in place on the drink stirrer, much like a kebab skewer spears and holds meat, vegetables and other foods when grilling. After a drink has been made and a one or more garnishes or other items are applied to the drink stirrer, the drink stirrer is inserted into the drink such that one end of the stirrer typically contacts the bottom of the drinking vessel (a cup, mug, bowl, glass, bottle, can or liquid or viscous content container) and a section of the drink stirrer, nearer the other end of the drink stirrer rests against the side of the drinking vessel keeping the one or more garnishes or other items near the top of drinking vessel and not in contact with the contents of the drinking vessel. In most cases the one or more garnishes or other items are positioned on the drink stirrer above the liquid line of the drink so that the one or more garnishes or other items do not contact with the drink itself until a user desires to do so. Another purpose of a drink stirrer is to allow the user to “mix” their drink by stirring the liquid in the drink after receiving it. If the drink is made from several different beverages or different alcoholic beverages, the bartender or “maker of the drink” may not have fully mixed the drink after creating it. Thus, the user can stir their drink once made and fully mix the drink's contents to effectuate a better tasting mixed drink. Drink stirrers have also been used as drink or container markers alerting users to identify their particular drinking vessel, especially if two or more users sitting together have ordered, or have, the same kind of drink or the same kind of drinking vessel.

Issues and problems with each of the above described uses of drink stirrers are as follows. Firstly, in the usage described above whereby the drink stirrer is used for holding and delivering one or more garnishes or other items to a user, drink stirrers traditionally hold the one or more garnishes or other items in place by friction between the garnish and drink stirrer. Depending on the kind of garnish, the “holding capability” of the drink stirrer to the one or more garnishes or other items can become less than optimal resulting in the release of the garnish from the drink stirrer due to the force of gravity and therefore the one or more garnishes or other items can slide or move down the drink stirrer into the drink. This is not a desired outcome for the user because when this happens the one or more garnishes or other items can become more soluble and begin to dissolve in the drink. This is especially an issue when drinks that include one or more garnishes are ordered and made in a restaurant or bar setting and can sometimes take additional time to be delivered to the person who ordered their drink. Another problem with this particular usage is that depending upon the number of garnishes or other items, their size and weight, the drink stirrer can become unbalanced and “top heavy” due to the one or more garnishes or other items being positioned near the top of the drink stirrer causing the drink stirrer, with garnish attached, to fall out of the drinking vessel.

In the above described usage of a drink stirrer as a drink or container marker, there is an issue which makes the typical drink stirrer effectively a poor choice for use as a drink or container marker. For example, after receiving a drink with a drink stirrer resting in a drinking vessel, a typical user either uses the drink stirrer to stir the drink, consume the garnishes or other items or remove the garnishes or other items from the drink stirrer subsequently depositing the garnishes or other items into their drink. At that time, there is no further use for the drink stirrer and it is typically placed on a nearby surface. If intended to use as drink or container marker, users are reticent to place the drink stirrer back into the drink after having placed it elsewhere outside the drinking vessel, possibly in an unsanitary location.

Therefore, a need exists to provide a stirring device having one or more additional functionalities such that it may hold a garnish or garnishes or other items securely in place in or about a cup, mug, bowl, glass, bottle, can or other liquid or viscous content container, out of contact with the liquid portion of a drink. Additionally, a need exists to provide a stirring device having one or more additional functionalities as a drink or container marker such that it can be placed on or about a drinking vessel without being re-inserted into the drinking vessel thereby not contacting the drink's liquid.

### BRIEF DESCRIPTION OF THE SEVERAL VIEWS OF THE DRAWING

FIG. 1 illustrates a general overview of the herein disclosed notched stirring device having additional functionalities, in accordance with an exemplary embodiment of the present invention;

FIG. 2 illustrates an isometric view of the herein disclosed notched stirring device having additional functionalities, in accordance with an exemplary embodiment of the present invention to demonstrate the stirring device as it may be used with a tumbler-type glass drinking vessel and with several items of garnish;

FIG. 3 illustrates a side view of the herein disclosed notched stirring device having additional functionalities, in accordance with an exemplary embodiment of the present invention to demonstrate the stirring device as it may be used with a pop-top type soda can drinking vessel and with several items of garnish;

FIG. 4 illustrates an isometric view of an alternative embodiment of the herein disclosed notched stirring device;

FIG. 5 illustrates an isometric view of another alternative embodiment of the herein disclosed notched stirring device;

FIG. 6 illustrates a view of another alternative embodiment of the herein disclosed notched stirring device demonstrating that the stirring device may have a width that varies depending upon the position along the elongated body;

FIG. 7 illustrates a side view of another alternative embodiment of the herein disclosed notched stirring device;

FIG. 8 illustrates a side view of another alternative embodiment of the herein disclosed notched stirring device;

FIG. 9 illustrates a side view of another alternative embodiment of the herein disclosed notched stirring device;

FIG. 10 illustrates a side view of another alternative embodiment of the herein disclosed notched stirring device;

FIG. 11 illustrates a side view of another alternative embodiment of the herein disclosed notched stirring device;

FIG. 12 illustrates a side view of another alternative embodiment of the herein disclosed notched stirring device;

FIG. 13 illustrates a side view of another alternative embodiment of the herein disclosed notched stirring device;

FIG. 14 illustrates a side view of another alternative embodiment of the herein disclosed notched stirring device;

FIG. 15 illustrates a side view of another alternative embodiment of the herein disclosed notched stirring device;

FIG. 16 illustrates a side view of another alternative embodiment of the herein disclosed notched stirring device;

FIG. 17 illustrates a side view of another alternative embodiment of the herein disclosed notched stirring device;

FIG. 18 illustrates a side view of another alternative embodiment of the herein disclosed notched stirring device;

FIG. 19 illustrates a method for producing a notched stirring device having additional functionalities, in accordance with the present invention; and

FIG. 20 illustrates an alternative method for producing a notched stirring device having additional functionalities, in accordance with the present invention.

### DETAILED DESCRIPTION OF THE INVENTION

The herein disclosed notched stirring device includes a decorative element forming a grip for a user, a piercing tip for protruding through a garnish, and an elongated body that spans between the decorative element and the piercing tip. The decorative element may be formed in a fanciful shape to facilitate identification of any of the following: identification of the owner of the drinking vessel (or owner of the contents of the drinking vessel—to identify whose drink it is at a party, for example); identification of the contents of the drinking vessel; identification of the garnish; identification of the origin of the stirring device (to promote a brand, for example). The elongated body forms one or more functional notches and may support (or restrain) one or more items of garnish. The one or more functional notches may include a first notch for receiving a first lip of the vessel.

Throughout this specification, the item for storing a liquid (or other material) is mostly referred to as a vessel or a drinking vessel, but the term vessel or drinking vessel is not meant to be limiting and is instead intended to include a wide variety of cups, mugs, bowls, glasses, bottles, cans, or any other container capable of holding liquid or another desired material.

Also throughout this specification, items that are intended to be pierced by the piercing tip and then supported or restrained by the elongated body (and/or the notches formed by the elongated body) are referred to as garnish, garnishes, or one or more garnishes. The term garnish is not intended to be limiting and is intended to include any relatively small item that may be suspended above, near, or in the liquid or other material being held by the vessel. The term relatively small is intended to include any item of any size that can fit on the elongated body of the herein disclosed notched stirring device. The garnish may be edible and may be a food item, but the term is also intended to include non-food and non-edible items such as decorations.

The term notch is mostly used herein to describe the recessed areas formed within the elongated body. The recessed areas may alternatively be referred to as cutouts, protrusions, or protruding areas. The notches are intended to receive a lip of the vessel and/or to restrain one or more garnishes. The term restrain is intended to include supporting one or more garnishes as well as providing increased frictional force to negate gravitational forces from causing the one or more garnishes to prematurely fall into the liquid within the vessel (or outside the vessel when utilized in a hanging or vertical position).

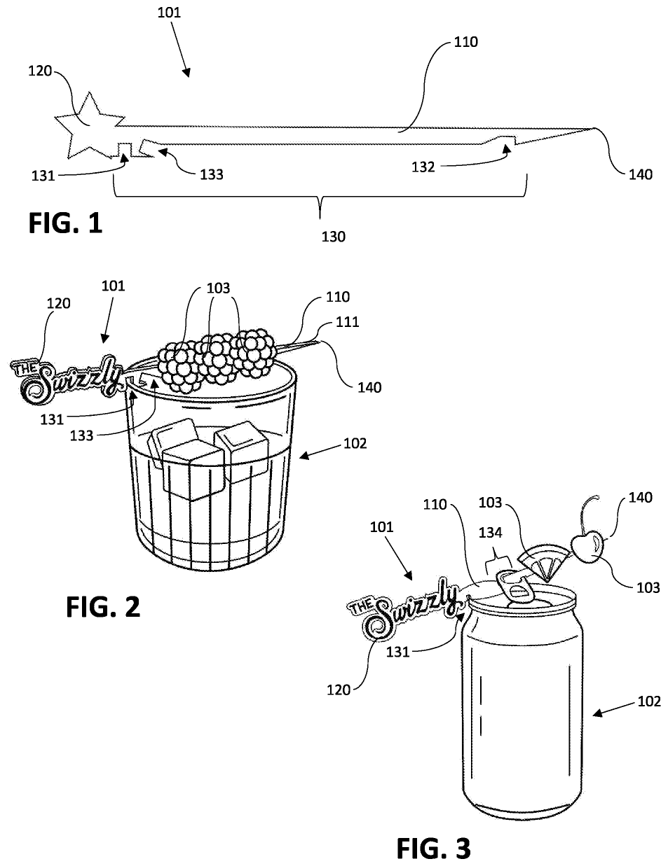

Referring to FIG. 1, a general overview of notched stirring device 101 is shown. Notched stirring device 101 includes decorative element 120, piercing tip 140, and elongated body 110 spanning between decorative element 120 and piercing tip 140.

Decorative element 120 may be formed in any fanciful shape to facilitate both holding the stirring device and providing identifying features that may be appreciated by either the user or other persons nearby. For example, decorative element 120 may be shaped with letters spelling a person's name in order to identify the owner of the drink. Or alternatively, decorative element 120 may be shaped with a company logo in order to provide marketing opportunities. In another alternative, decorative element 120 may be shaped to appear as a food item—such as a raspberry—in order to identify either the contents of the drink in the vessel or the intended garnish.

Piercing tip 140 is formed by a relatively narrow portion of elongated body 110. Piercing tip 140 is intended to be capable of piercing through one or more items of garnish, but piercing tip 140 may be formed in any shape and does not necessarily have to be formed as a sharp point. For example, piercing tip 140 may be rounded, hooked, or even bulbous, as can be seen in FIG. 15, FIG. 16, and FIG. 18.

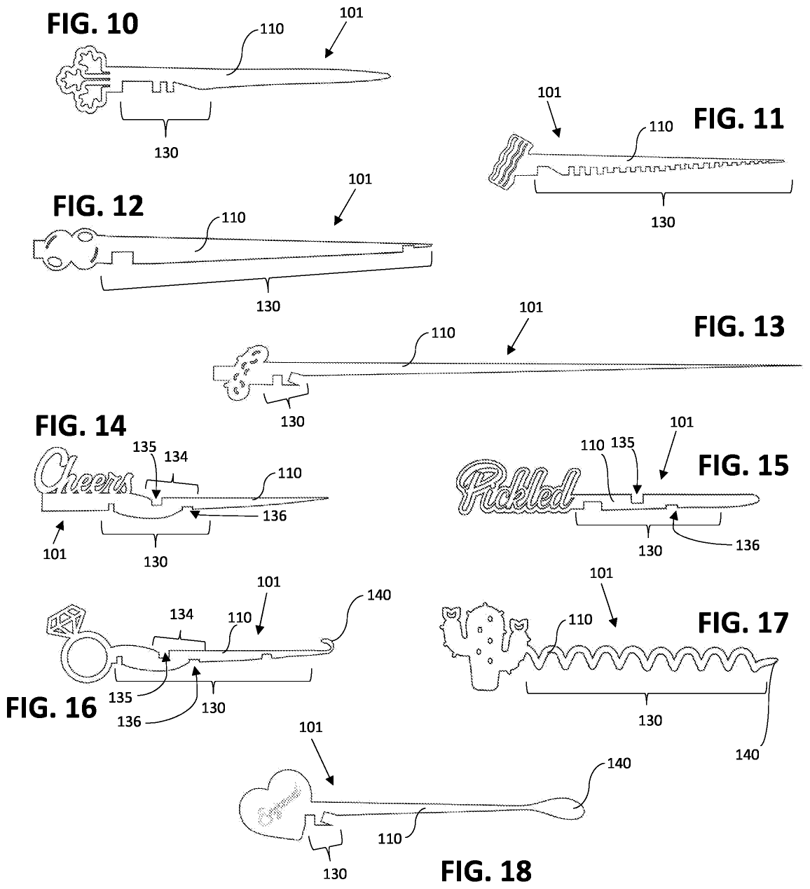

Elongated body 110 may have width 111 and may be formed in any length or with any cross-section, depending on the intended use or the intended garnish. In certain embodiments, elongated body 110 may be forked; in other words, elongated body 110 may branch into two or more bodies along all or part of its length. Elongated body 110 forms one or more functional notches 130. Functional notches 130 may include one or more notches formed nearby decorative element 120, or may include a variety of notches formed at varying points along elongated body 110. Several examples of alternative elongated bodies, and their corresponding notches, are illustrated in FIGS. 1 through 18.

In a preferred embodiment, and as depicted in FIG. 1, one or more functional notches 130 includes first notch 131 formed in close proximity to decorative element 120 and second notch 132 formed in close proximity to piercing tip 140. First notch 131 and second notch 132 may be formed at a distance apart that corresponds to the distance between a first lip of a drinking vessel and a second lip of the drinking vessel (the lip opposite to the first lip). First notch 131 and second notch 132 are utilized when it is desired to place notched stirring device 101 in a horizontal orientation (which may also be referred to as a horizontal position) such that first notch 131 is attached to a vessel at a first lip and second notch 132 is attached to a vessel at a second lip.

As also depicted in FIG. 1, one or more functional notches may additionally include vertical hanging notch 133. Vertical hanging notch 133 is formed in relatively close proximity to decorative element 120. In certain embodiments, vertical hanging notch 133 may be formed near to first notch 131. Vertical hanging notch 133 is formed at an angle so that when notched stirring device 101 is hung on a lip of a vessel via vertical hanging notch 133, notched stirring device 101 is securely held in a vertical orientation such that decorative element 120 is positioned at a higher point than piercing tip 140. When positioned in this vertical orientation, notched stirring device 101 may be positioned so that elongated body 110 is either outside the drinking vessel or inside the drinking vessel. Vertical hanging notches 133 can be seen in many of the example embodiments illustrated in the various figures.

Notched stirring device 101 may be formed of any material that may be suitable for piercing food products and for mixing beverages that are to be consumed by humans. For example, notched stirring device 101 may be formed of wood, plastic, metal, rubber, paper, silicon, cork, leather, etc. Furthermore, notched stirring device 101 may be formed of a first material for certain portions and a second material for other portions. For example, one or more functional notches 130 may be formed and then reinforced by adding a material that differs (and is perhaps stronger and/or more durable) from the material of elongated body 110.

Referring to FIG. 2, notched stirring device 101 is shown in use to hold garnish 103 in a horizontal position above the liquid level of vessel 102. In this way, stirring device 101 can be used advantageously to keep garnish 103 in a secure position (via one or more additional notches that are obscured by garnish 103) above a tumbler-glass type drinking vessel 102. If it is desired to place the stirring device into a vertical position with garnish 103 hanging either outside vessel 102 or inside vessel 102, a user may utilize vertical hanging notch 133 to reposition notched stirring device 101 into the vertical position.

Referring to FIG. 3, notched stirring device 101 is shown in use to hold garnish 103 in a relatively horizontal position above a soda-can type drinking vessel 102. As can be seen in FIG. 3, notched stirring device 101 is secured in place via first notch 131 receiving a first lip of vessel 102 and via one or more tab notches 134 receiving the tab for vessel 102. As is apparent in FIG. 3, more than one type (and more than one item) of garnish may be supported by elongated body 110 of notched stirring device 101.

As can also be seen in FIG. 3, one or more tab notches 134 may be formed within elongated body 110. Tab notches 134 can include a first tab notch positioned on a top side of elongated body 110 (and therefore on the opposite side of first notch 131, which is positioned on a bottom side of elongated body 110), and a second tab notch positioned on the bottom side of elongated body 110. Notched stirring device 101 fits through the tab of the soda-can type drinking vessel and attaches so that the first tab notch receives a first side of the tab and the second tab notch receives a second side of the tab. In this way, stirring device 101 can be securely (but removably) attached to a soda-type can drinking vessel. Tab notches 134 are also included in the alternative embodiments depicted in FIG. 14, FIG. 15, and FIG. 16.

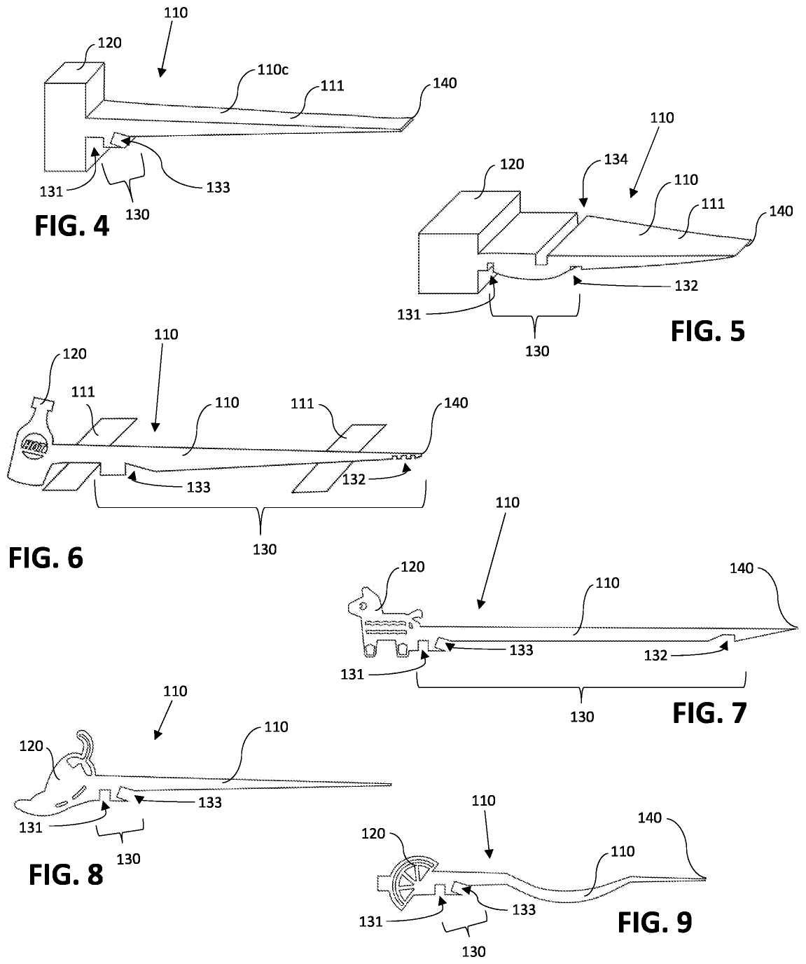

Referring to FIG. 4 through FIG. 18, several alternative embodiments for the herein disclosed notched stirring device 101 are shown to demonstrate possibilities for elongated body 101, for width 111 of elongated body 101, for one or more functional notches 130, for decorative element 120, and for piercing tip 140.

For example, FIG. 4 and FIG. 5 depict notched stirring device 101 having width 111 and having a relatively plain (and non-fanciful) decorative element that is intended to provide a grip for a user. FIG. 6 depicts the possibility of width 111 varying depending on the particular location along elongated body 110. For example, elongated body 110 may be formed to have a relatively wide width 111 at a first position that corresponds to a first lip of a vessel and at a second position that corresponds to a second (or opposite) lip of the vessel.

FIG. 9 depicts notched stirring device 101 having an elongated body 110 that is not straight, but instead includes a bend in the middle portion to facilitate holding certain garnishes. FIG. 10 and FIG. 11 depicts notched stirring devices 101 having alternative arrangements for the one or more functional notches 130. In FIG. 10, one or more functional notches 130 are located near to the decorative element. In FIG. 11, a multitude of notches are formed at functional notches 130 which may be advantageous to restrain a higher number of garnishes.

FIG. 13 and FIG. 17 depict alternative shapes for elongated body 110. In FIG. 13, a relatively long elongated body 110 is provided and in FIG. 17, a corkscrew is formed by elongated body 110.

FIG. 14, FIG. 15, and FIG. 16 depict alternative embodiments intended to be used with soda-can type drinking vessels having a tab (which may also be referred to as a pop-top). Notched stirring device 101 may include one or more tab notches 134 for receiving a tab of a drinking vessel. One or more tab notches may include a first tab notch 135 for receiving a first side of a tab and may include a second tab notch 136 for receiving a second side of a tab.

FIG. 16 and FIG. 18 depict alternative shapes for piercing tip 140. In FIG. 16, a hooked piercing tip 140 is provided and in FIG. 18, a rounded or bulbous piercing tip 140 is provided. These examples are provided to demonstrate that pierced tip 140 may not be sharp. Such non-sharp pierced tips may advantageously prevent a pierced garnish from slipping off of elongated body 110.

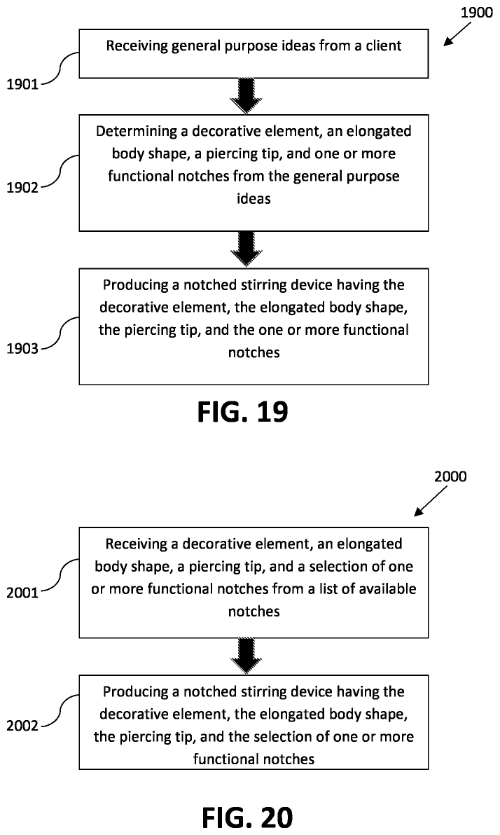

The present invention also includes methods for producing notched stirring devices having additional functionalities. Referring to FIG. 19, method 1900 for producing a notched stirring device is provided. Method 1900 for producing a notched stirring device having additional functionalities includes step 1901 receiving general purpose ideas from a client. When producing a notched stirring device specifically for a client or customer, a first methodology involves asking questions of a client in order to receive information regarding the client's general purpose in acquiring stirring devices. For example, the client may desire to create a stirring device for use with raspberry garnishes and tumbler-type glasses.

Once this type of general purpose information or ideas are received from the client or customer, a determination at step 1902 can be made from the information of a particular decorative element that will work with the general purpose information, of a particular elongated body shape that will work with the general purpose information, of a particular piercing tip that will work with the general purpose information, and of one or more functional notches that will work with the general purpose information.

And then, after a determination is made is step 1902, the notched stirring device is produced in step 1903 having the decorative element determined in step 1902, the elongated body shape determined in step 1902, the piercing tip determined in step 1902, and the one or more notches determined in step 1902.

Referring to FIG. 20, alternative method 2000 is shown for producing notched stirring device 101. Method 2000 involves direct solicitation of features from a client or customer. For example, step 2001 of method 2000 includes receiving a particular decorative element selection from the client, receiving a particular elongated body shape selection from the client, receiving a particular piercing tip selection from the client, and receiving a particular selection of one or more functional notches from a list of available notches from the client. Then, step 2002 of method 2000 includes producing a notched stirring device having the particular selections previously received in step 2001. In this way, a client or customer may select all aspects of a functional stirring device to optimize the notched stirring device.

While the present invention has been illustrated and described herein in terms of a preferred embodiment and several alternatives, it is to be understood that the devices described herein can have a multitude of additional uses and applications. Accordingly, the invention should not be limited to just the particular description and various drawing figures contained in this specification, that merely illustrate a preferred embodiment and application of the principles of the invention. It should be noted that terms of orientation, such as horizontal and vertical and up and down, and direction such as top, bottom, front, rear, etc. as used herein are used to distinguish elements from one another within exemplary embodiments and should therefore not be taken as limiting the scope of the present invention to any specific orientation. Moreover, the use of the terms first, second, etc. do not denote any order or importance, but rather are used to distinguish one element from another. Furthermore, the use of terms a, an, etc. do not denote a limitation of quantity, but rather denote the presence of at least one of the referenced item. Therefore, the detailed description and accompanying drawings are not to be taken in a limiting sense, but rather to enable the present invention.

What is claimed is:

1. A notched stirring device for stirring a liquid contained in a vessel having a first lip and a second lip, the stirring device comprising:
a decorative element forming a grip for a user, wherein the decorative element is formed in a fanciful shape to facilitate identification for the user;
a piercing tip for protruding through a garnish; and
an elongated body spanning between the decorative element and the piercing tip, wherein the elongated body forms one or more functional notches and wherein the elongated body supports the garnish;
wherein the one or more functional notches includes a first notch for receiving the first lip of the vessel.

2. The notched stirring device as recited in claim 1, wherein the one or more functional notches further includes a second notch for receiving the second lip of the vessel.

3. The notched stirring device as recited in claim 2, wherein the first notch and the second notch are oriented so that the stirring device lies horizontally across the vessel.

4. The notched stirring device as recited in claim 2, wherein the one or more functional notches further includes a third notch for restraining the garnish.

5. The notched stirring device as recited in claim 2, wherein the one or more functional notches includes one or more notches positioned on an opposite side of the elongated body from the first notch.

6. The notched stirring device as recited in claim 5, wherein one or more notches positioned on the opposite side of the elongated body are for restraining the garnish.

7. The notched stirring device as recited in claim 1, wherein the elongated body has a width and wherein the width is optimized for the garnish.

8. The notched stirring device as recited in claim 1, wherein the elongated body has a width and wherein the width varies along a length of the elongated body.

9. The notched stirring device as recited in claim 1, wherein the elongated body has a first width at a first position and a second width at a second position.

10. The notched stirring device as recited in claim 9, wherein the first position corresponds to the first lip of the vessel and wherein the second position corresponds to the second lip of the vessel.

11. The notched stirring device as recited in claim 1, wherein the piercing tip is rounded to provide increased safety.

12. The notched stirring device as recited in claim 1, wherein the elongated body forms a corkscrew shape and wherein the one or more functional notches are formed by the corkscrew shape.

13. The notched stirring device as recited in claim 1, wherein the elongated body is formed of a first material and wherein a second material is attached at the one or more functional notches.

14. The notched stirring device as recited in claim 1, wherein the elongated body is formed of a flexible material to facilitate use with vessels having a variety of sizes.

15. The notched stirring device as recited in claim 1, wherein the one or more functional notches further includes a vertical hanging notch that places the notched stirring device in a vertical orientation when the vertical hanging notch is attached at the first lip.

16. The notched stirring device as recited in claim 15, wherein the vertical hanging notch is formed at an angle.

17. A method for producing a notched stirring device for stirring a liquid contained in a vessel having a first lip and a second lip, the method comprising the steps of:
receiving general purpose ideas from a client;
determining a decorative element, an elongated body shape, a piercing tip, and one or more functional notches from the general purpose ideas; and
producing a stirring device having the decorative element, the elongated body shape, the piercing tip, and the one or more functional notches.

18. The method as recited in claim 17, wherein the general purpose ideas include an identification of a preferred garnish and an identification of a preferred vessel.

19. A method for producing a notched stirring device for stirring a liquid contained in a vessel having a first lip and a second lip, the method comprising the steps of:
receiving a decorative element, an elongated body shape, a piercing tip, and a selection of one or more functional notches from a list of available notches from a client; and
producing a stirring device having the decorative element, the elongated body shape, the piercing tip, and the one or more functional notches.

20. The method as recited in claim 19, further comprising the step of receiving a width for the elongated body and wherein the step of producing the stirring device includes producing the stirring device having the width.
